(19) United States
(12) Patent Application Publication
(10) Pub. No.: US 2016/0283045 A1
(43) Pub. Date: Sep. 29, 2016

(54) Interface adjustment apparatus and method using ultrasonic transceivers

(71) Applicant: Knowles Electronics, LLC, Itasca, IL (US)

(72) Inventor: Eric J. Lautenschlager, Geneva, IL (US)

(73) Assignee: Knowles Electronics, LLC, Itasca, IL (US)

(21) Appl. No.: 15/081,608

(22) Filed: Mar. 25, 2016

Related U.S. Application Data
(60) Provisional application No. 62/139,099, filed on Mar. 27, 2015.

(51) Int. Cl. G06F 3/0481

(52) U.S. Cl. CPC G06F 3/0481

(57) ABSTRACT

Apparatuses and methods directed to adjusting a visual characteristic of a user interface. Ultrasonic detection times are received from a first ultrasonic transceiver, a second ultrasonic transceiver, and a fourth ultrasonic transceiver. A height of a feature above the user interface is determined from the first ultrasonic detection time, the second ultrasonic detection time, and the third ultrasonic detection time. If the height of the feature is less than a predetermined threshold a visual characteristic of the user interface is adjusted.

### CROSS-REFERENCE TO RELATED APPLICATIONS

This application claims the benefit of and priority to U.S. Provisional Application No. 62/139,099, filed Mar. 27, 2015, the entire contents of which are hereby incorporated by reference.

### TECHNICAL FIELD

This application relates to ultrasonic transceivers and utilizing these devices to determine whether to adjust characteristics of a user interface or characteristics of items presented at a user interface.

### BACKGROUND OF THE INVENTION

Different types of user interfaces exist and one type of user interface is a keyboard or keypad. Smart phones and tablets often present the keyboard to a user as part of a touch screen. In these cases, alphanumeric keys are displayed on the touch screen and the user touches the screen about the key they wish to select. Unfortunately, the displays presented on touch screens are sometimes small. If the display is too small, the user has a hard time contacting or striking the correct key or in some cases strikes an incorrect key.

Still another type of interface also utilizes a touch screen but presents icons (instead or in addition to alphanumeric keys) on the interface to a user. For example, this type of interface may be utilized as part of a cellular phone or smart phone. As with the displays involving keyboards, the icons may sometimes be too small for a correct selection to be made. If the display is small, the user has a hard time contacting or striking the intended icon and sometimes contacts the incorrect icon.

When the incorrect key or icon is contacted, the user may have to re-do their work. For example, if the user were typing an email, they may have to re-type portions of the message or even start over. If a user selects the incorrect icon, an unintended application may launch wasting both user and system resources.

Previous approaches have not adequately addressed these problems. As a result, some user dissatisfaction with these previous approaches has occurred.

### BRIEF DESCRIPTION OF THE DRAWINGS

For a more complete understanding of the disclosure, reference should be made to the following detailed description and accompanying drawings wherein:

FIG. 1 comprises a block diagram of a system using ultrasonic information to alter characteristics of features displayed on a user interface according to various embodiments of the present invention;

FIG. 2 comprises a diagram of a grid or bin pattern used to identify locations on a user interface according to various embodiments of the present invention;

FIG. 3 comprises a flow chart showing one approach for adjusting features on a user interface according to various embodiments of the present invention;

FIG. 4 comprises a flow chart and associated block diagrams showing one approach for determining the location of a feature at a user interface according to various embodiments of the present invention;

FIG. 5 comprises a flow chart and associated block diagrams showing one approach for determining the location of a feature at a user interface according to various embodiments of the present invention;

FIG. 6 comprises a flow chart and associated block diagrams showing one approach for determining the height of a feature according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The present approaches provide an adjustable interface whereby characteristics (e.g., the size) of displayable graphic units or graphic display units (e.g., alphanumeric keys or icons) are adjusted as a feature of interest (e.g., a finger) approaches a displayable graphic unit. These approaches utilize one or more ultrasonic transceivers that transmit an ultrasonic signal (and receive a reflected ultrasonic signal in return). The received ultrasonic signal(s) are used to identify a graphic display unit (e.g., key) and determine whether the feature of interest (e.g., the finger) is within a predetermined distance (e.g., height) of the graphic display unit so that characteristics of the graphical display unit can be altered.

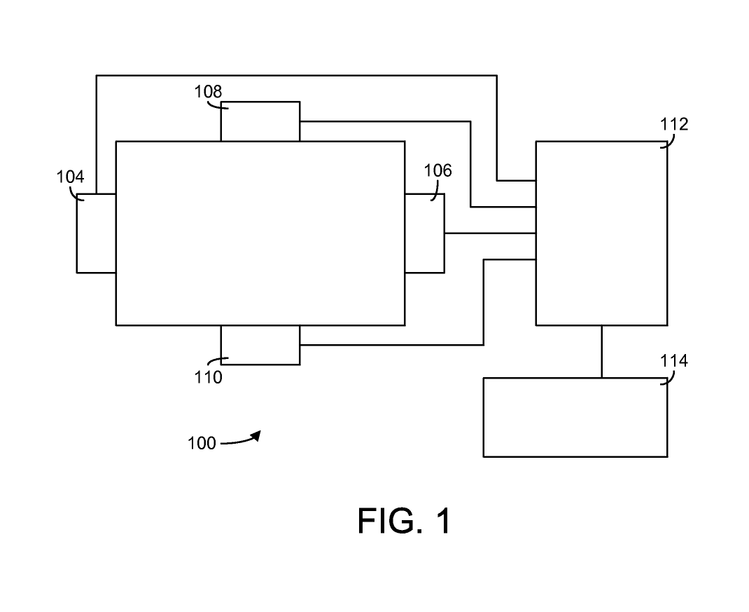

Referring now to FIG. 1, one example of an apparatus or system 100 arranged to detect a reflective feature and alter one or more display characteristics of graphic display units (e.g., keys or icons) of an interface or what is being displayed on the interface is described. The apparatus 100 includes a user interface 102, a first ultrasonic transceiver 104, a second ultrasonic transceiver 106, a third ultrasonic transceiver 108, a fourth ultrasonic transceiver 110, a processor 112, and a display controller 114. The number and position of these transceivers is not limited to those shown in the drawings, which represents one possible example configuration. Other examples are possible.

The user interface 102 is any type of user display that presents information to a user. In one example, the user interface is a touch screen that as described elsewhere herein is divided into bins (i.e., a grid pattern). Graphical display units (e.g., alphanumeric keys or icons) are presented to the user on the user interface. Characteristics such as the length, width, color, intensity, and resolution of the graphical display units may be changed. The graphical display units are the collection of pixels that form an image. For example, the pixels may form an image of the letter “A” or an icon representing a website. Other examples are possible.

The first ultrasonic transceiver 104, second ultrasonic transceiver 106, third ultrasonic transceiver 108, and fourth ultrasonic transceiver 110 transmit ultrasonic signals and receive reflected ultrasonic signals back. As used herein, “ultrasonic” means signals in the 20-200 KHz frequency range. The transceivers 104, 106, 108, and 110 also convert the returned signal into the appropriate format that can be processed by a digital signal processing device. For example, the transceivers 104, 106, 108, and 110 convert the received signals into distance information in an appropriate format for a digital processing device (e.g., the processor 112).

In these regards, the transceivers 104, 106, 108, and 110 measure signal path times and object detection times for features approaching the user interface. As used herein, signal path time is the time from which the signal is generated at the transceiver, propagates at the speed of sound to the reflective feature (e.g., a finger), travels back from the reflective feature to the transceiver (at the speed of sound) and is sensed by the transceiver. In other words, this is the total time a signal takes to go from the transceiver to the reflective feature and then back to the transceiver. The object detection time is one-half the signal path time.

The processor 112 receives information from the transceivers 104, 106, 108, and 110 (which indicates potentially that a feature of interest is approaching the user interface 102) and maps this information to a particular bin (an area as described below) on the display. The identified bin then maps to a particular graphic display unit (e.g., key on a keyboard or icon). When the feature (e.g., the finger) approaching the graphical display unit is a predetermined distance from the user interface 102, a command is sent to the display controller 114 to alter a characteristic of the visual item (e.g., increase the size of a key or icon).

The display controller 114 is configured to drive the user interface 102. For example, the display controller 114 receives information from the processor telling it how to adjust the screen and then has appropriate hardware/software to make the changes to the user interface 102. In one example, the user interface 102 is a touch screen with keys (as the graphic display units) and the display controller 114 increases the size (e.g., doubles or triples) of a particular key that is identified in the command from the processor 112.

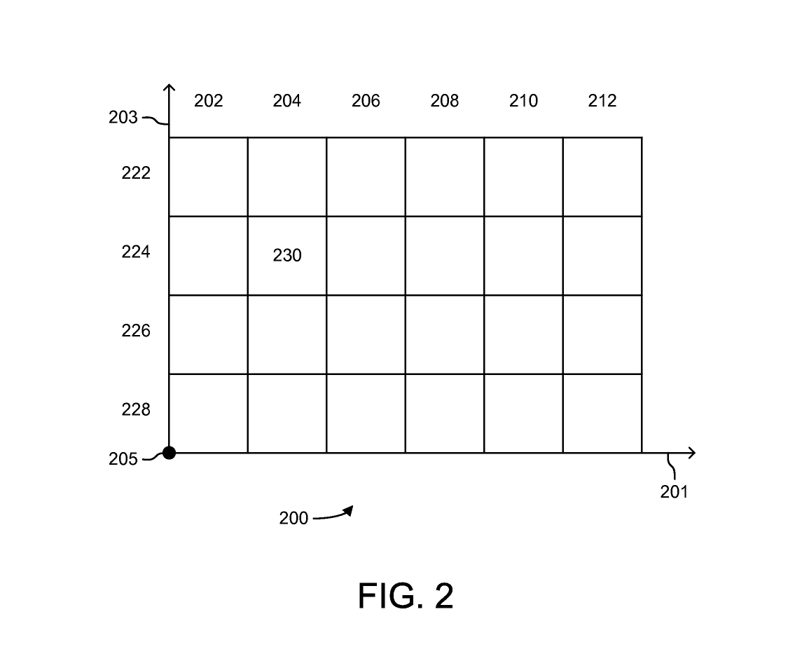

Referring now to FIG. 2, one example of a user interface (e.g., a touch screen) and its divisions are described. The interface 200 is presented against a coordinate system that is a Cartesian plane (having x-axis 201, y-axis 203, and origin 205). The interface 200 is divided into vertical columns or bins 202, 204, 206, 208, 210, and 212. The interface 200 is also divided into horizontal columns or bins 222, 224, 226, and 228. Each column is defined by a width in arbitrary units, while each row is defined by a width in arbitrary units. The intersection of columns and rows also forms a smaller bin, for example, bin 230, where column 204 intersects row 224. Within each bin are a multitude of Cartesian (x, y) points. The goal of the many of the approaches described herein is to determine which bin (e.g., bin 230) an external feature (e.g., finger) is approaching, to map the identified bin to a graphical display unit (e.g., to map that the finger is approaching the letter “X”), and to alter the characteristics (e.g., size) of that graphical display unit (e.g., to increase the size of the letter “X”). The number of row and column bins is not limited by the drawing references, but can vary based upon the specific display or keyboard application.

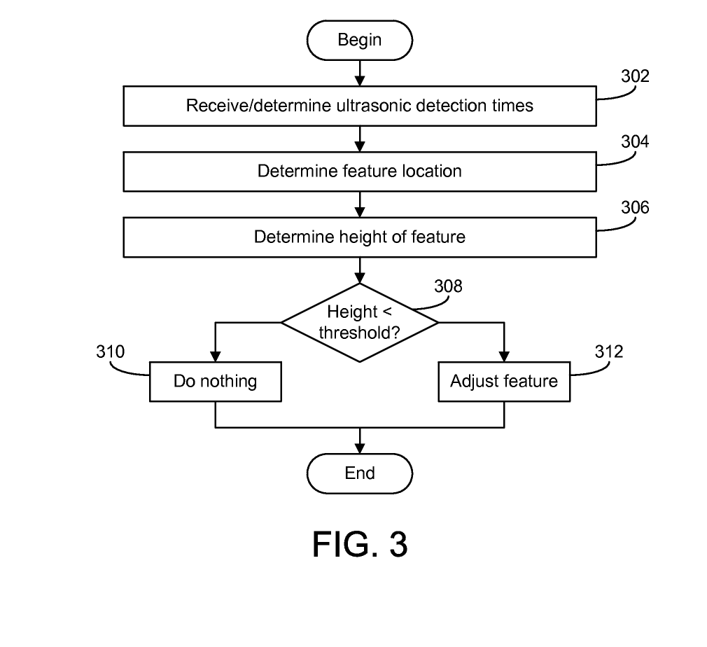

Referring now to FIG. 3, one example of an overall approach for altering characteristics of a user interface is described. At step 302, ultrasonic detection times are received from one or more ultrasonic transceivers. These may include the signal path time and the object detection time for a feature (e.g., a finger) approaching the user interface.

At step 304, the feature location is determined from the ultrasonic detection times that have been received from one or more ultrasonic transceivers. Various approaches may be utilized to accomplish this functionality and one such example is described elsewhere herein.

At step 306, the height of the feature is determined from the ultrasonic detection times. For example, the height of the finger that is approaching the user interface (the height being the distance between the finger and the interface) is determined.

At step 308, it is determined if the height is below a predetermined threshold. If the answer is negative, the system does nothing (e.g., no alteration to the user interface is made) at step 310. If the answer is affirmative, at step 312, characteristics of the feature are adjusted.

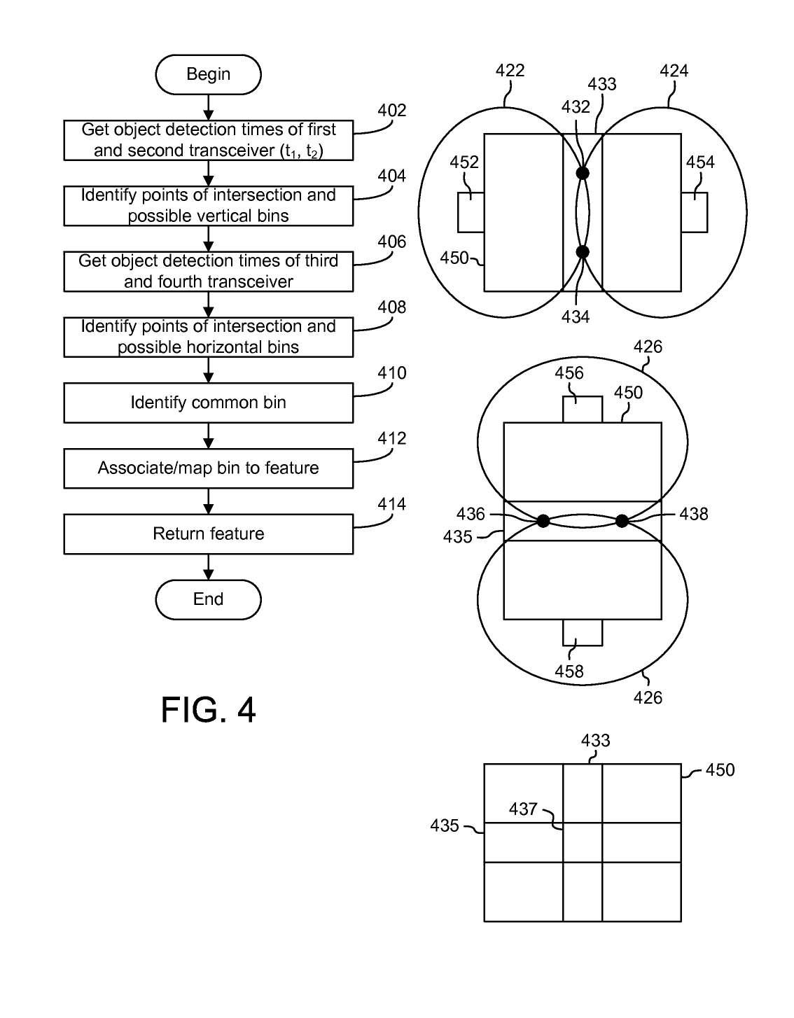

Referring now to FIG. 4, one example of an approach for determining feature location at an interface is described. The approach of FIG. 4 may implement step 304 of FIG. 3. The example of FIG. 4 assumes that there is a first ultrasonic transceiver 452, a second ultrasonic transceiver 454, a third ultrasonic transceiver 456, and a fourth ultrasonic transceiver 458 arranged around the periphery of an interface 450. In this example, the first ultrasonic transceiver 452 is across from the second ultrasonic transceiver 454, and the third ultrasonic transceiver 456 is across from the fourth ultrasonic transceiver 458.

At step 402, objection detection times are received from the first ultrasonic transceiver 452 and the second ultrasonic transceiver 454. At step 404, the times define circles 422 and 424 on the display that intersect at points 432 and 434 and these points are determined at this step. These points also identify a vertical bin 433.

At step 406, objection detection times are received from the third ultrasonic transceiver 456 and the fourth ultrasonic transceiver 458. At step 408, the times define circles 426 and 428 on the display that intersect at points 436 and 438 and these points are determined at this step. These points also identify a vertical bin 435.

At step 410, the common bin (the intersection of bin 433 and bin 435) is determined.

At step 412, the common bin is mapped to a visual item (the graphical display unit) associated with the bin (e.g., in this example, bin 437 may be mapped to a key or icon).

At step 414, the identified graphical display unit is returned to the main calling approach, for example, as the result of step 304 of FIG. 3.

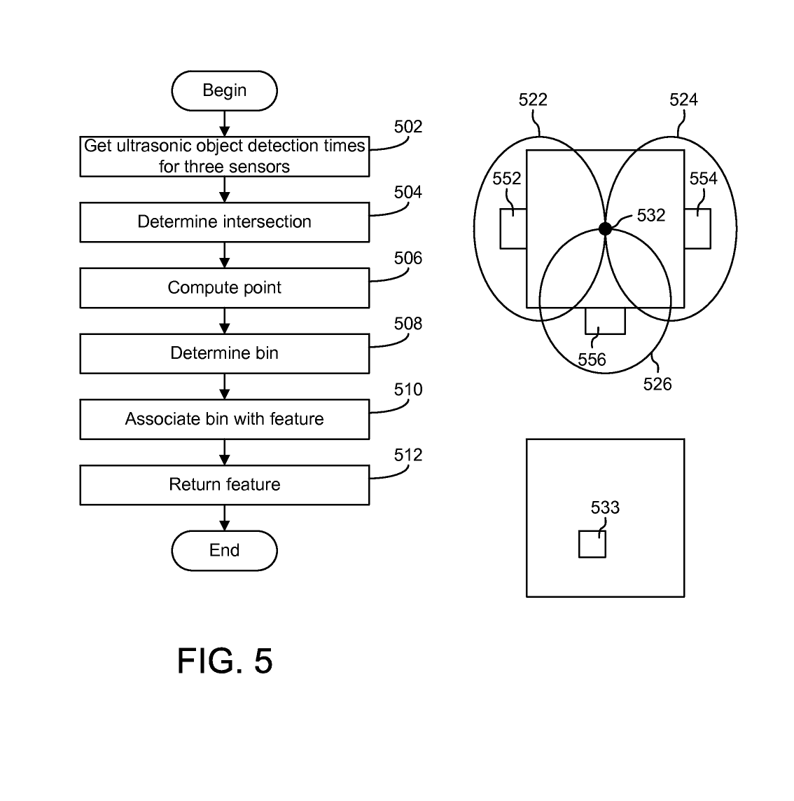

Referring now to FIG. 5, another example of an approach for determining feature location at an interface is described. The approach of FIG. 5 may implement step 304 of FIG. 3. The example of FIG. 5 assumes that there is a first ultrasonic transceiver 552, a second ultrasonic transceiver 554, and a third ultrasonic transceiver 556 arranged around the periphery of an interface 550. In this example, the first ultrasonic transceiver 552 is across from the second ultrasonic transceiver 554.

At step 502, objection detection times are received from the first ultrasonic transceiver 552, the second ultrasonic transceiver 554, and the third ultrasonic transceiver 556. At step 504, the times are used to define three circles 522, 524, and 526 that intersect at point 532 and determined at step 506. At step 508, this point 532 also identifies a unique bin 533.

At step 510, the bin 533 is mapped to a visual item (the graphical display unit) associated with the bin (e.g., in this example, bin 533 may be mapped to a key or icon).

At step 512, the identified graphical display unit is returned to the main calling approach, for example, as the result of step 304 of FIG. 3.

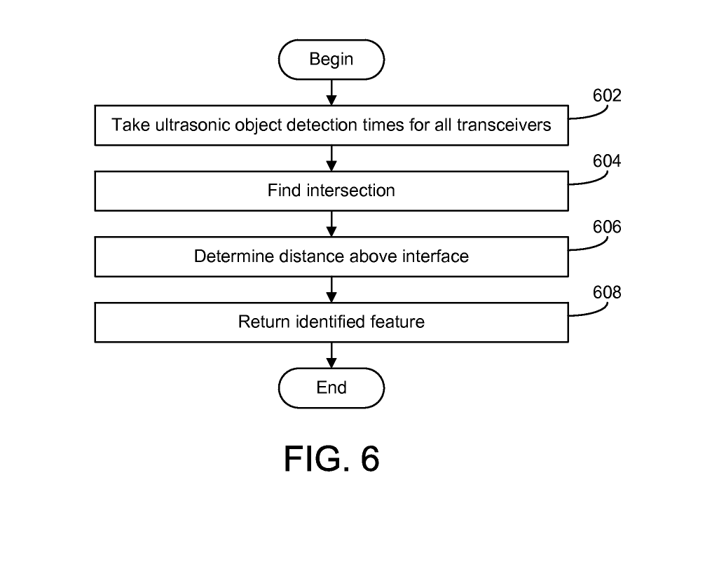

Referring now to FIG. 6, one example of an approach for determining feature height at an interface is described. The approach of FIG. 6 may implement step 306 of FIG. 3.

At step 602, the object detection times for all transceivers are taken. At step 604, the intersection of these times is determined. In these regards, it will be appreciated that the times define three-dimensional spheres. When four sensors are used, there will be a unique intersection of four spheres (each sphere having a radius equal to the object detection time as measured at a particular sensor). The intersection will be a point and this point can be determined be various mathematic approaches as known to those skilled in the art.

At step 606, the height of the feature can be determined, for example, by knowing the coordinates of the plane representing the user interface and by knowing the point of intersection determined at step 604, a distance there between can be determined using appropriate mathematical techniques known to those skilled in the art. At step 608, the identified graphical display unit is returned to the main calling approach, for example, as the result of step 306 of FIG. 3.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A user interface adjustment apparatus comprising:
a first ultrasonic transceiver configured to:
send and receive first ultrasonic signals; and
determine a first ultrasonic detection time based upon the sent and received first ultrasonic signals;
a second ultrasonic transceiver configured to:
send and receive second ultrasonic signals; and
determine a second ultrasonic detection time based upon the sent and received second ultrasonic signals;
a third ultrasonic transceiver configured to:
send and receive third ultrasonic signals; and
determine a third ultrasonic detection time based upon the sent and received third ultrasonic signals; and
one or more electronic processors configured to:
receive the first ultrasonic detection time, the second ultrasonic detection time, and the third ultrasonic detection time;
determine a height of a feature above a user interface from the first ultrasonic detection time, the second ultrasonic detection time, and the third ultrasonic detection time;
determine the height of the feature is less than a predetermined threshold; and
adjust a visual characteristic of the user interface based upon the height of the feature being less than the predetermined threshold.

2. The user interface adjustment apparatus of claim 1, wherein the one or more electronic processors are further configured to determine a feature location of the feature from the first ultrasonic detection time, the second ultrasonic detection time, and the third ultrasonic detection time, wherein the feature location indicates a location on the user interface below the feature.

3. The user interface adjustment apparatus of claim 2, wherein the one or more electronic processors are further configured to:
determine a bin of the user interface where the feature location is located; and
determine a visual item located within the bin, wherein the adjusted visual characteristic is a visual characteristic of the visual item.

4. The user interface adjustment apparatus of claim 3, wherein to adjust the visual characteristic the one or more electronic processors are configured to increase a size of the visual item.

5. The user interface adjustment apparatus of claim 4, wherein the size of the visual item is doubled.

6. The user interface adjustment apparatus of claim 4, wherein the size of the visual item is tripled.

7. The user interface adjustment apparatus of claim 2, wherein to determine the feature location of the feature the one or more electronic processors are further configured to:
determine a first circle based upon the first ultrasonic detection time;
determine a second circle based upon the second ultrasonic detection time;
determine a third circle based upon the third ultrasonic detection time; and
determine an intersection of the first circle, the second circle, and the third circle, wherein the intersection is the feature location.

8. The user interface adjustment apparatus of claim 2, further comprising:
a fourth ultrasonic transceiver configured to:
send and receive fourth ultrasonic signals; and
determine a fourth ultrasonic detection time based upon the sent and received fourth ultrasonic signals.

9. The user interface adjustment apparatus of claim 8, wherein to determine the feature location of the feature the one or more electronic processors are further configured to:
determine a first circle based upon the first ultrasonic detection time;
determine a second circle based upon the second ultrasonic detection time;
determine first intersection points of the first circle and the second circle;
identify a first bin associated with the first intersection points;
determine a third circle based upon the third ultrasonic detection time;
determine a fourth circle based upon the fourth ultrasonic detection time;
determine second intersection points of the third circle and the fourth circle;
identify a second bin associated with the second intersection points;
identify a third bin based upon an intersection of the first bin and the second bin, wherein the feature location is the third bin.

10. The user interface adjustment apparatus of claim 8, wherein to determine the height of the feature above the user interface the one or more electronic processors are further configured to:
determine a first sphere based upon the first ultrasonic detection time;
determine a second sphere based upon the second ultrasonic detection time;
determine a third sphere based upon the third ultrasonic detection time;
determine a fourth sphere based upon the fourth ultrasonic detection time;
determine an intersection for the first sphere, the second sphere, the third sphere, and the fourth sphere;
determine the height of the feature based upon a plane of the user interface and the intersection.

11. The user interface adjustment apparatus of claim 1, wherein the first ultrasonic detection time is a signal path time.

12. The user interface adjustment apparatus of claim 1, wherein the first ultrasonic detection time is an object detection time.

13. A method of adjusting a user interface, the method comprising:
receiving, from a first ultrasonic transceiver, a first ultrasonic detection time;
receiving, from a second ultrasonic transceiver, a second ultrasonic detection time;
receiving, from a third ultrasonic transceiver, a third ultrasonic detection time;
determining a height of a feature above a user interface from the first ultrasonic detection time, the second ultrasonic detection time, and the third ultrasonic detection time;
determining the height of the feature is less than a predetermined threshold; and
adjusting a visual characteristic of the user interface based upon the height of the feature being less than the predetermined threshold.

14. The method of claim 13, further comprising determining a feature location of the feature from the first ultrasonic detection time, the second ultrasonic detection time, and the third ultrasonic detection time, wherein the feature location indicates a location on the user interface below the feature.

15. The method of claim 14, further comprising:
determining a bin of the user interface where the feature location is located; and
determining a visual item located within the bin, wherein the adjusted visual characteristic is a visual characteristic of the visual item.

16. The method of claim 15, wherein adjusting the visual characteristic comprises increasing the size of the visual item.

17. The method of claim 14, wherein determining the feature location comprises:
determining a first circle based upon the first ultrasonic detection time;
determining a second circle based upon the second ultrasonic detection time;
determining a third circle based upon the third ultrasonic detection time; and
determining an intersection of the first circle, the second circle, and the third circle, wherein the intersection is the feature location.

18. The method of claim 14, further comprising:
receiving, from a fourth ultrasonic transceiver, a fourth ultrasonic detection time.

19. The method of claim 18, wherein determining the feature location of the feature comprises:
determining a first circle based upon the first ultrasonic detection time;
determining a second circle based upon the second ultrasonic detection time;
determining first intersection points of the first circle and the second circle;
identifying a first bin associated with the first intersection points;
determining a third circle based upon the third ultrasonic detection time;
determining a fourth circle based upon the fourth ultrasonic detection time;
determining second intersection points of the third circle and the fourth circle;
identifying a second bin associated with the second intersection points;
identifying a third bin based upon an intersection of the first bin and the second bin, wherein the feature location is the third bin.

20. The method of claim 18, wherein determining the height of the feature above the user interface comprises:
determining a first sphere based upon the first ultrasonic detection time;
determining a second sphere based upon the second ultrasonic detection time;
determining a third sphere based upon the third ultrasonic detection time;
determining a fourth sphere based upon the fourth ultrasonic detection time;
determining an intersection for the first sphere, the second sphere, the third sphere, and the fourth sphere;
determining the height of the feature based upon a plane of the user interface and the intersection.
